(19) United States
(12) Patent Application Publication
(10) Pub. No.: US 2007/0169993 A1
(43) Pub. Date: Jul. 26, 2007

(54) Emergency release apparatus

(76) Inventor: Dae-Ok Rhee, Seoul (KR)

Correspondence Address: OSTROLENK FABER GERB & SOFFEN, 1180 AVENUE OF THE AMERICAS, NEW YORK, NY, 100368403, US

(21) Appl. No.: 10/590,403

(22) PCT Filed: Feb. 22, 2005
(86) PCT No.: PCT/KR05/00477

§ 371 Date: Aug. 23, 2006

(30) Foreign Application Priority Data
Feb. 23, 2004 (KR) 10-2004-0011987
Mar. 31, 2004 (KR) 10-2004-0022387

(51) Int. Cl. A62B 1/16

(52) U.S. Cl. 182/3; 182/142

(57) ABSTRACT

An emergency release apparatus comprises: an air tube having an accommodation space for an evacuee and for protecting the evacuee from an external impact; a rope connected to the air tube, having one end fixed to an evacuation place, and having a length long enough to reach the ground; and a controller mounted in the air tube and connected to the rope, for descending the air tube in which the evacuee is accommodated to the ground at a safe speed. Accordingly, the apparatus protects the evacuee from an external impact, etc. when the evacuee descends to the ground.

### TECHNICAL FIELD

The present invention relates to an emergency release apparatus, and more particularly, to an emergency release apparatus capable of helping an evacuee to safely descend to the ground at the time of an emergency such as building fire.

### BACKGROUND ART

Generally, an emergency release apparatus installed at a high building is implemented as a controller that helps an evacuee to safely descend to the ground at the time of an emergency such as building fire. The emergency release apparatus using the controller adopts the following two methods.

First, a controller is installed at an outer wall of a building and a rope is mounted to the controller so that an evacuee can safely descend to the ground by grasping the rope. Under this state, the controller is operated to slowly descend the rope, and thereby the evacuee can evacuate to the ground.

Second, a rod is mounted to an outer wall of a building and a controller is installed at the rod so that an evacuee can directly operate the controller after clinging to the controller.

### DISCLOSURE OF INVENTION

### TECHNICAL-PROBLEM

However, in case of the first method, the evacuee has to move to a place where the controller is installed thereby to cause inconvenience. Also, since it takes a lot of time for the evacuee to move to the place where the controller is installed, an evacuation is delayed.

In case of the second method, when the evacuee descends to the ground by the controller, the evacuee's eyes are opened to cause horror and thereby the evacuee can not smoothly descent to the ground.

Also, since the evacuee descends to the ground without an additional protecting equipment, the evacuee may collide to the building or the rope may be cut off thereby to cause a damage to the evacuee's life.

### TECHNICAL-SOLUTION

Therefore, an object of the present invention is to provide an emergency release apparatus capable of helping an evacuee to safely descend to the ground at the time of an emergency such as building fire by covering the evacuee's eyes to make the evacuee feel comfortable and by accommodating the evacuee in a capsule type air tube.

To achieve these and other advantages and in accordance with the purpose of the present invention, as embodied and broadly described herein, there is provided an emergency release apparatus comprising: an air tube having an accommodation space for an evacuee and for protecting the evacuee from an external impact; a rope connected to the air tube, having one end fixed to an evacuation place, and having a length long enough to reach the ground; and a controller mounted in the air tube and connected to the rope, for descending the air tube in which the evacuee is accommodated to the ground at a safe speed.

The air tube includes: an external member formed as an oval shape; and an internal member having a gas filling space between the external member and having a space therein for accommodating the evacuee.

An entry for allowing the evacuee to enter is formed at a lateral surface of the air tube in a longitudinal direction, and the entry is provided with a zipper for opening and closing the entry.

A pair of arm openings for allowing the evacuee's arms to extend outward and a pair of leg openings for allowing the evacuee's legs to extend outward are respectively formed at a front surface of the air tube. A zipper is respectively provided at the arm openings and the leg openings.

A transparent window for allowing the evacuee to see outside when the evacuee is accommodated in the air tube is formed at a front surface of the air tube. Also, the transparent window is provided with an opening/closing member for opening and closing the transparent window.

The emergency release apparatus further comprises a gas tank for storing compression gas to be supplied to the gas filling space of the air tube. A gas outlet of the gas tank is connected to the air tube by a gas supplying pipe, and the gas outlet is provided with an opening/closing valve for opening and closing the gas outlet.

The emergency release apparatus further comprises an air bag installed at an inner floor surface of the air tube and protecting the evacuee from an impact generated when the air tube reaches the ground. The air bag is instantaneously swollen by an impact detecting portion installed at a lower surface of the air tube when an impact more than a preset value is generated, thereby protecting the evacuee accommodated in the air tube.

### DESCRIPTION OF DRAWINGS

FIG. 1 is a frontal view showing an emergency release apparatus according to the present invention;

FIG. 2 is a lateral view showing the emergency release apparatus according to the present invention;

FIG. 3 is a sectional view taken along line III-III in FIG. 1;

FIG. 4 is a sectional view taken along line IV-IV in FIG. 1;

FIG. 5 is a sectional view taken along line V-V in FIG. 1;

FIG. 6 is a sectional view taken along line VI-VI in FIG. 1;

FIG. 7 is an enlargement view of part ‘A’ of FIG. 3;

FIG. 8 is an enlargement view of part ‘B’ of FIG. 4;

FIG. 9 is an enlargement view of part ‘C’ of FIG. 5;

FIG. 10 is a sectional view taken along line X-X in FIG. 2;

FIG. 11 is a construction view showing a controller according to the present invention;

FIGS. 12 and 13 are operation state views of the emergency release apparatus according to the present invention;

FIG. 14 is a lateral view showing an emergency release apparatus according to a second embodiment of the present invention;

FIG. 15 is a disassembled perspective view showing an air resisting portion of the emergency release apparatus according to the second embodiment of the present invention;

FIG. 16 is a lateral view showing an emergency release apparatus according to a third embodiment of the present invention; and

FIG. 17 is a lateral view showing an emergency release apparatus according to a fourth embodiment of the present invention.

### BEST MODE

Reference will now be made in detail to the preferred embodiments of the present invention, examples of which are illustrated in the accompanying drawings.

Hereinafter, an emergency release apparatus according to the present invention will be explained.

Even if there may exist a plurality of preferred embodiments of the present invention, the most preferred embodiment will be explained.

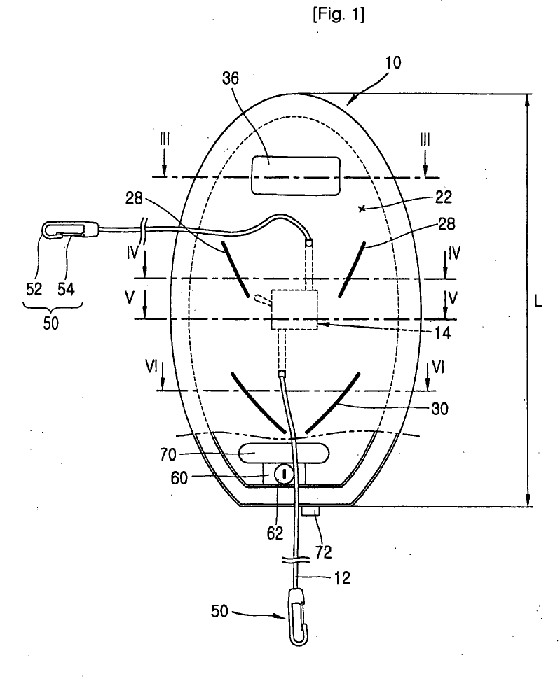

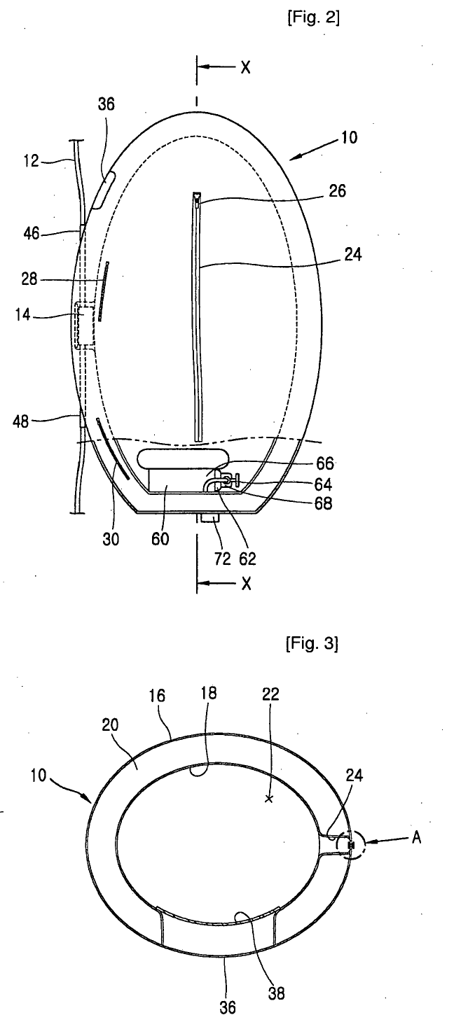

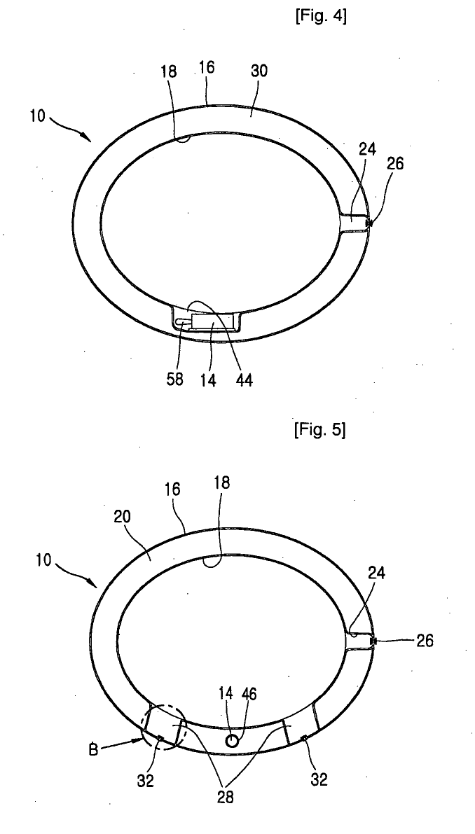

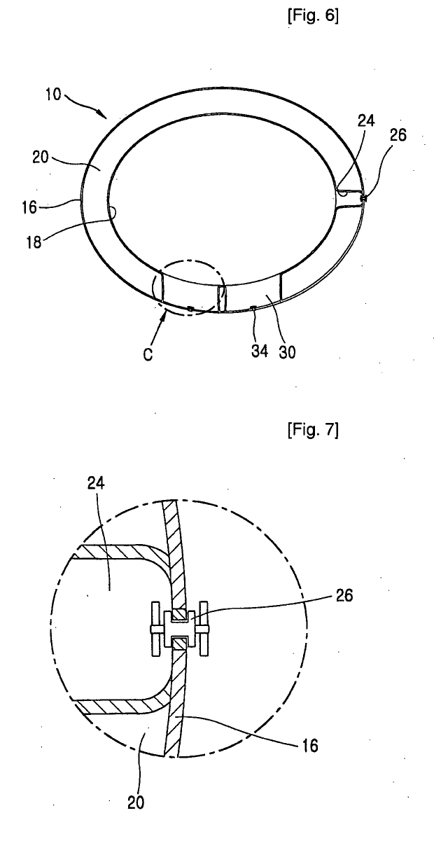

FIG. 1 is a frontal view showing an emergency release apparatus according to the present invention, FIG. 2 is a lateral view showing the emergency release apparatus according to the present invention, FIG. 3 is a sectional view taken along line III-III in FIG. 1, FIG. 4 is a sectional view taken along line IV-IV in FIG. 1, FIG. 5 is a sectional view taken along line V-V in FIG. 1, and FIG. 6 is a sectional view taken along line VI-VI in FIG. 1.

The emergency release apparatus according to the present invention comprises: an air tube 10 having an accommodation space for an evacuee and for protecting the evacuee from an external impact; a rope 12 connected to the air tube 10, having one end fixed to an evacuation place, and having a length long enough to reach the ground; and a controller 14 mounted in the air tube 10 and connected to the rope 12, for descending the air tube 10 in which the evacuee is accommodated to the ground at a safe speed.

The air tube 10 includes: an external member 16 for forming an appearance thereof; and an internal member 18 having a gas filling space 20 between the external member 16 and having a space 22 therein for accommodating the evacuee. Preferably, a width between the external member 16 and the internal member 18 is formed to be 10˜15 cm enough to protect the accommodated evacuee from an external impact. Also, it is preferable that the air tube 10 is formed of a fireproofing material such as fiber or rubber.

The air tube 10 has a size large enough to accommodate at least one person. That is, in case of evacuating an old and feeble person or a child who has a difficulty in putting on the air tube 10, the old and feeble person or the child can be accommodated in the air tube 10 with the evacuee.

An entry 24 for allowing the evacuee to enter the air tube 10 is formed at a lateral surface of the air tube 10 in a longitudinal direction. Also, as shown in FIG. 7, the entry 24 is provided with a zipper 26 for opening and closing the entry 24.

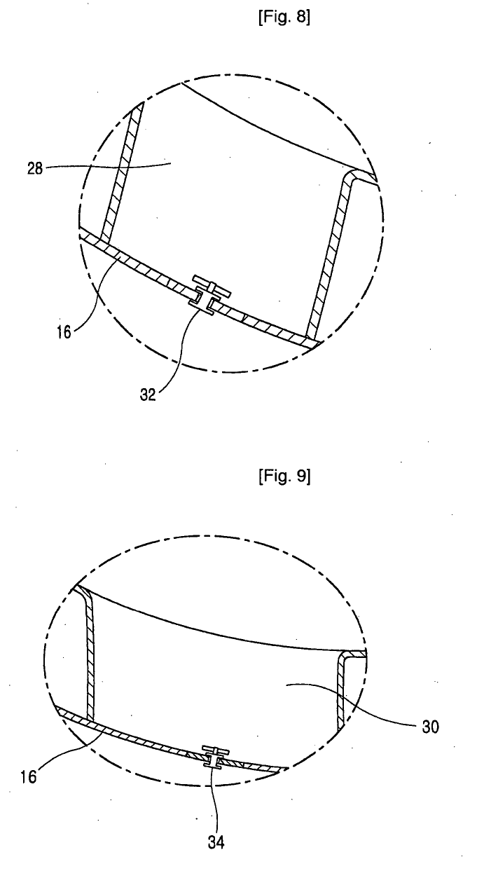

A pair of arm openings 28 for allowing the evacuee's arms to extend outward and a pair of leg openings 30 for allowing the evacuee's legs to extend outward are respectively formed at a front surface of the air tube 10. As shown in FIG. 8, a zipper 32 for opening and closing the arm openings is respectively provided at the arm openings 30. Also, as shown in FIG. 9, a zipper 34 for opening and closing the leg openings 30 is respectively provided at the leg openings 30.

A transparent window 36 for allowing the evacuee to see outside when the evacuee is accommodated in the air tube 10 is formed at a front surface of the air tube 10. Also, the transparent window 36 is provided with an opening/closing member 38 for opening and closing the transparent window 36.

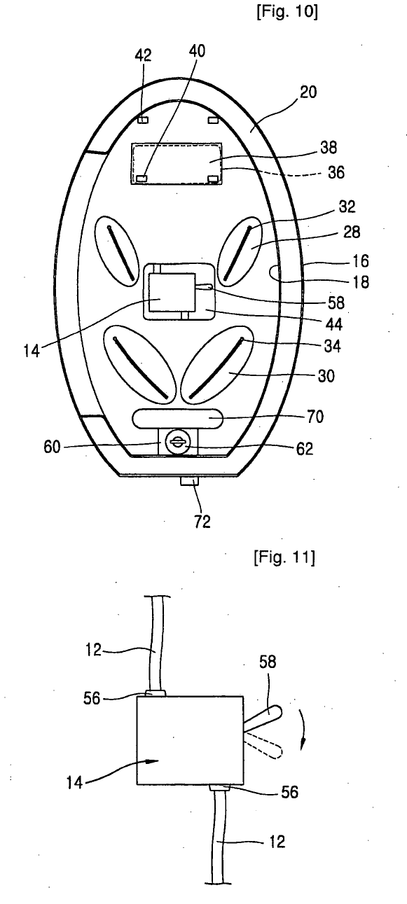

As shown in FIG. 10, the opening/closing member 38 has a size large enough to cover the transparent window 36, and has an upper end fixed to an inner side surface of the air tube 10. Also, an adhesive tape 40 such as a velcro is mounted at a lower end of the opening/closing member 38 to be adhered to an adhesive tape 42 mounted at an inner side surface of the air tube 10.

When the evacuee is to know the external circumstance through the transparent window 36, the opening/closing member 38 is lifted upwardly and the adhesive tape 40 mounted at the opening/closing member 38 is attached to the adhesive tape 42 mounted at the inner side surface of the air tube thereby to open the transparent window 36. On the contrary, if the opening/closing member 38 is pulled downward, the transparent window 36 is covered.

A controller mounting portion 44 for mounting the controller 14 is formed at a front side of the inner side surface of the air tube 10. Also, rope guiding pipes 46 and 48 connected to the controller 14 and for passing the rope 12 are respectively mounted at upper and lower ends of the controller mounting portion 44.

The rope guiding pipes 46 and 48 are composed of: a first guiding pipe 46 penetratingly formed at a front upper side of the air tube 10, for passing the rope 12 connected to an upper side of the controller 14; and a second guiding pipe 48 penetratingly formed at a front lower side of the air tube 10, for passing the rope 12 connected to a lower side of the controller 14.

The rope 12 has a length long enough to reach the ground from each floor, and a connection ring 50 for fast and conveniently fixing the rope 12 to a fixed object is respectively mounted at both ends of the rope 12.

The connection ring 50 is composed of: a hook connected to the rope 12 and having one opened side; and an elastic opening/closing portion 54 mounted at the opened portion of the hook 52, for closing the opened portion of the hook 52 with a certain elastic force.

As shown in FIG. 11, the controller 14 is mounted in the controller mounting portion 44 formed at an inner front side of the air tube 10, and a rope passage 56 for passing the rope 14 is respectively formed at upper and lower ends of the controller 14. Also, a lever 58 adjusted by the evacuee inside the air tube 10 is mounted at a front side of the controller 14.

When the evacuee pulls down the lever 58, the controller 14 is slowly descended along the rope. Also, when the lever 58 is restored to the original state, the controller 14 is stopped at the current position. As the controller 14, any controller that can be slowly lowered along the rope 12 is possible.

A gas tank 62 for storing compression gas to be supplied to the gas filling space 20 of the air tube 10 is mounted at a floor surface of the accommodation space 22 of the air tube 10.

The gas tank 62 is fixed to a tank mounting portion 60 formed at the floor surface of the accommodation space 22 of the air tube 10, and stores compression gas such as carbon dioxide, etc. therein. A gas outlet 68 of the gas tank 62 is connected to the air tube 10 by a gas supplying pipe 66, and the gas outlet 68 is provided with an opening/closing valve 64 for opening and closing the gas outlet 68.

An air bag 70 for protecting the evacuee from an impact generated when the air tube 10 reaches the ground is installed at an inner floor surface of the air tube 10.

The air bag 70 is for protecting the evacuee inside the air tube 10 in case that the rope 12 is cut off when the evacuee inside the air tube 10 descends to the ground or in case that an impact is generated when the rope 12 collides with the floor surface at a fast speed. If an impact more than a preset value is generated when the air tube 10 collides with the floor surface, the air bag 70 is instantaneously swollen to protect the evacuee inside the air tube 10.

The air bag 70 is operated by an impact detecting portion 72 installed at a lower end of the air tube 10 and detecting an impact when the air tube 10 collides with the floor surface. That is, if an impact generated when the air tube 10 collides with the floor surface is more than a preset value, the impact detecting portion 72 operates the air bag 70.

As the air bag 70, a general air bag for a vehicle that protects a passenger by bursting open when an impact is applied thereto is used.

An operation of the emergency release apparatus according to the present invention will be explained as follows.

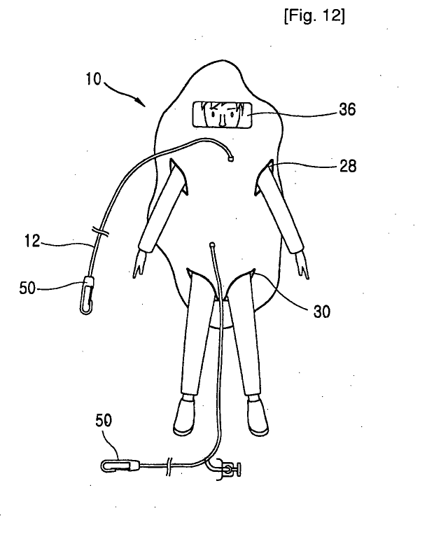

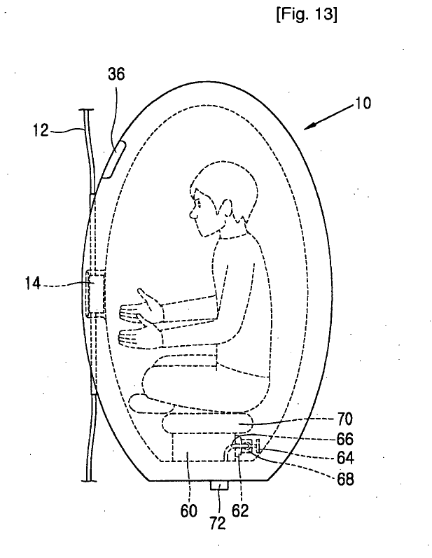

FIGS. 12 and 13 are operation state views of the emergency release apparatus according to the present invention.

In case that fire breaks out in a high building and thereby it is impossible for an evacuee to descend to the ground through stairs, etc., the emergency release apparatus is operated.

First, the evacuee selects a window or a veranda, etc. from where the evacuee descends to the ground, and fixes the connection ring 50 mounted at the upper end of the rope 12 to a fixed portion of an indoor room having a weight more than the evacuee's weight. The hook 52 has only to be fixed to the fixed portion thereby to have a usage convenience. Also, since the elastic opening/closing portion 54 covers the opened portion of the hook 52, the connection ring 50 is prevented from being detached from the fixed portion.

The distance between the rope 12 and the air tube 10 is properly controlled and the zipper 26 mounted at the entry 24 is opened, thereby opening the entry 24. Also, the zipper 32 of the arm openings 28 is opened to open the arm openings 28, and the zipper 34 of the leg openings 30 is opened to open the leg openings 30.

In case that the entry 24, the arm openings 28, and the leg openings 30 are initially opened, the evacuee does not have to open them additionally.

Then, the evacuee enters the accommodation space 22 of the air tube 10 through the entry 24, and extends his two arms outside the air tube 10 through the arm openings 28 and extends his two legs outside the air tube 10 through the leg openings 30.

Then, the evacuee moves to the place from where the evacuee is to descend to the ground, and moves to an outer wall of the building with grasping the rope 12 by his hands. As the result, the air tube 10 hangs in the air.

Then, the evacuee puts his arms and legs in the accommodation space 22 of the air tube 10, and closes the zipper 32 mounted at the arm openings 28 to close the arm openings 28 and closes the zipper 34 mounted at the leg openings 30 to close the leg openings 30.

The evacuee opens the transparent window 36 or covers the transparent window 36 by using the opening/closing member 38.

Under the state, when the evacuee opens the opening/closing valve 64 of the gas tank 62 in the air tube 10, gas of a high pressure inside the gas tank 62 is injected into the gas filling space 20 of the air tube 10 and thereby the air tube 10 is swollen as a capsule shape.

As the evacuee adjusts the lever 58 of the controller 14, the air tube 10 is slowly descended by the controller 14.

It is possible to accommodate not only the evacuee who adjusts the controller 14 but also other persons in the air tube 10. That is, in case that the evacuee evacuates with an old and feeble person or a child, the old and feeble person or the child have a difficulty in putting on the air tube 10. Accordingly, the air tube 10 is constructed to accommodate the old and feeble person or the child with the evacuee who adjusts the controller 14.

When the rope 12 is cut off while the air tube 10 descends to the ground or when the air tube 10 collides with the ground at a fast speed to generate an impact, the air bag 70 mounted in the air tube 10 is swollen thereby to attenuate the impact generated when the air tube 10 collides with the ground.

When the air tube 10 collides with the ground, the impact detecting portion is operated to detect a generated impact. If the impact is more than a preset value, the air bag 70 is operated. Then, the air bag 70 is instantaneously swollen thereby to minimize the impact to be transmitted to the evacuee.

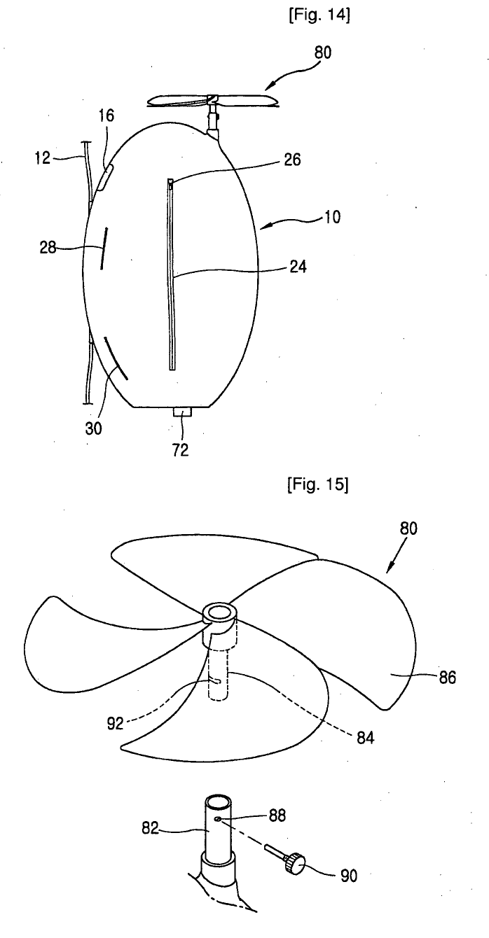

FIG. 14 is a lateral view showing an emergency release apparatus according to a second embodiment of the present invention, and FIG. 15 is a disassembled perspective view showing an air resisting portion of the emergency release apparatus according to the second embodiment of the present invention.

The emergency release apparatus according to the second embodiment of the present invention is the same as the emergency release apparatus according to the first embodiment of the present invention except that an air resisting portion 80 for generating an air resistance when the air tube 10 falls down is installed at an upper side of the air tube 10.

The air resisting portion 80 includes: a rod 82 upwardly protruded from the upper end of the air tube 10; a supporting axis 84 inserted into the rod 82 to be fixed; and a propeller 86 rotatably mounted at the supporting axis 84.

The rod 82 is provided with a bolt coupling hole 88 for coupling a fixing bolt 90, and a groove 92 for stepping the fixing bolt 90 is formed at an outer circumferential surface of the supporting axis 84. That is, as the supporting axis 84 is inserted into the rod 82 and the fixing bolt 90 is fastened, the fixing bolt 90 is stepped by the groove 92 of the supporting axis 84. Accordingly, the supporting axis 84 is prevented from being detached from the rod 82.

In the emergency release apparatus according to the second embodiment of the present invention, when the rope 12 is cut off while the air tube 10 falls down or when the air tube 10 falls down under a state that the rope 12 is not supported, the propeller 86 of the air resisting portion 80 is rotated to generate an air resistance. Accordingly, the air tube 10 descends to the ground without flipping the bottom portion to the top portion thereof, thereby preventing the evacuee's head from colliding with the ground first.

Also, the air bag 70 mounted at the floor surface of the air tube 10 is not swollen when the air tube 10 collides with the ground with flipping the bottom portion to the top portion thereof. The air tube 10 falls down without flipping the bottom portion to the top portion thereof by the air resisting portion 80. Accordingly, the air bag 70 is precisely operated when the air tube 10 collides with the ground thereby to protect the evacuee.

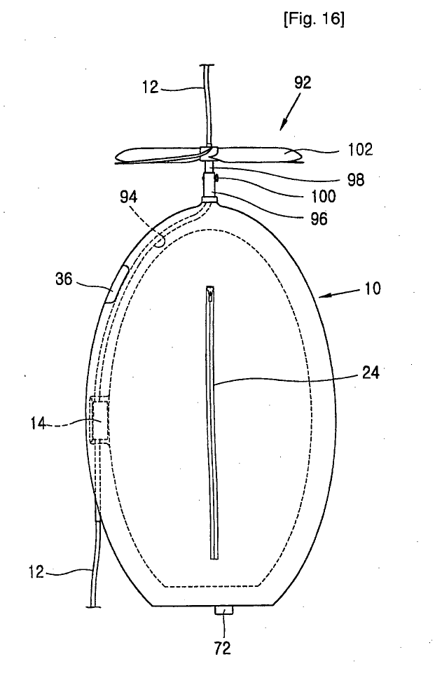

FIG. 16 is a lateral view showing an emergency release apparatus according to a third embodiment of the present invention.

The emergency release apparatus according to the third embodiment of the present invention is the same as the aforementioned emergency release apparatus except that an air resisting portion 92 for generating an air resistance when the air tube 10 falls down is installed at an upper side of the air tube 10.

The air resisting portion 92 according to the third embodiment of the present invention includes: a rod 96 upwardly protruded from the center of the upper end of the air tube 10; a supporting axis 98 inserted into the rod 96 to be fixed to the rod 96 by a fixing bolt 100, and having a passage for passing the rope 12 in a longitudinal direction thereof; and a propeller 102 rotatably mounted at the supporting axis 98.

The air tube 10 is provided with a guide passage 94 for guiding the rope 12 to the supporting axis 98, and the rope 12 is extended to an upper direction of the propeller 102.

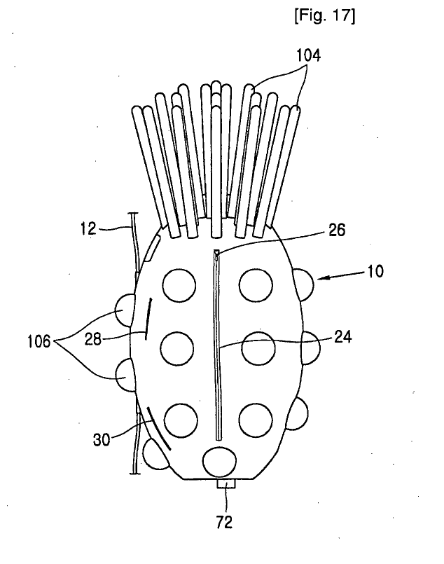

FIG. 17 is a lateral view showing an emergency release apparatus according to a fourth embodiment of the present invention.

The emergency release apparatus according to the fourth embodiment of the present invention is the same as the aforementioned emergency release apparatus except that an air bar 104 is installed at an upper side of the air tube 10 and a plurality of buffering protrusions 106 for absorbing an impact when the air tube 10 collides with the ground are formed at an outer surface of the air tube 10.

A plurality of the air bars 104 are provided at the upper end of the air tube 10, and the air bar 104 is formed as a stick shape having a certain length so that gas to be supplied to the gas filling space 20 of the air tube 10 can be supplied thereto.

The buffering protrusions 106 are formed as a convex semi-sphere at an outer circumferential surface of the air tube 10, and are connected to the gas filling space 20 of the air tube 10. Accordingly, gas to be supplied to the gas filling space 20 of the air tube 10 is injected into the buffering protrusions 106.

The air bar 104 and the buffering protrusions 106 can be constructed to have a shape to be mounted to the body, and can be formed of foam of a synthetic resin.

In the emergency release apparatus according to the present invention, the evacuee can descend to the ground in a state of being accommodated in the air tube of a capsule shape, thereby protecting the evacuee from an external impact, etc.

Also, since the evacuee's eyes can be covered by his selection, the evacuee can feel comfortable at the time of descending to the ground in a state of being accommodated in the air tube.

When the rope 12 is cut off while the air tube 10 descends to the ground or when the air tube 10 collides with the ground at a fast speed, the air bag is swollen thereby to protect the evacuee accommodated in the air tube.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An emergency release apparatus comprising:
an air tube having an accommodation space for an evacuee and for protecting the evacuee from an external impact;
a rope connected to the air tube, having one end fixed to an evacuation place, and having a length long enough to reach the ground; and
a controller mounted in the air tube and connected to the rope, for descending the air tube in which the evacuee is accommodated to the ground at a safe speed.

2. The apparatus of claim 1, wherein the air tube comprise:
an external member formed as an oval shape; and
an internal member having a gas filling space between the external member and having a space therein for accommodating the evacuee.

3. The apparatus of claim 2, wherein a width between the external member and the internal member is formed to be 10˜15 cm enough to protect the evacuee accommodated in the air tube from an external impact.

4. The apparatus of claim 1, wherein the air tube is formed of a fireproofing material.

5. The apparatus of claim 1, wherein an entry for allowing the evacuee to enter the air tube is formed at a lateral surface of the air tube in a longitudinal direction, and the entry is provided with a zipper for opening and closing the entry.

6. The apparatus of claim 1, wherein a pair of arm openings for allowing the evacuee's arms to extend outward, a pair of leg openings for allowing the evacuee's legs to extend outward are respectively formed at a front surface of the air tube, and a zipper is respectively provided at the arm openings and the leg openings.

7. The apparatus of claim 1, wherein a transparent window for allowing the evacuee to see outside when the evacuee is accommodated in the air tube is formed at a front surface of the air tube, and the transparent window is provided with an opening/closing member for opening and closing the transparent window.

8. The apparatus of claim 1, wherein a controller mounting portion for mounting the controller is formed at a front inner surface of the air tube, and rope guiding pipes connected to the controller and for passing the rope are respectively mounted at upper and lower ends of the controller mounting portion.

9. The apparatus of claim 8, wherein a rope passage for passing the rope is respectively formed at upper and lower ends of the controller, and a lever adjusted by the evacuee inside the air tube is mounted at a front side of the controller.

10. The apparatus of claim 1, wherein the rope has a length long enough to reach the ground from each floor, and a connection ring for fixing the rope to a fixed object is respectively mounted at both ends of the rope.

11. The apparatus of claim 1, further comprising a gas tank mounted at one side of the air tube and for storing compression gas to be supplied to the gas filling space of the air tube.

12. The apparatus of claim 11, wherein the gas tank is mounted at a tank mounting portion mounted at a floor surface of the accommodation space of the air tube.

13. The apparatus of claim 11, wherein a gas outlet of the gas tank is connected to the air tube by a gas supplying pipe, and the gas outlet is provided with an opening/closing valve for opening and closing the gas outlet.

14. The apparatus of claim 1, further comprising an air bag installed at an inner floor surface of the air tube and for protecting an evacuee from an external impact generated when the air tube reaches the ground.

15. The apparatus of claim 14, wherein the air bag is instantaneously swollen by an impact detecting portion installed at a lower surface of the air tube when an impact more than a preset value is generated, thereby protecting the evacuee accommodated in the air tube.

16. The apparatus of claim 1, further comprising an air resisting portion mounted at an upper side of the air tube and for generating an air resistance so that the air tube can fall down without flipping a bottom portion thereof to a top portion thereof.

17. The apparatus of claim 16, wherein the air resisting portion comprises:
a rod mounted at an upper end of the air tube;
a supporting axis fixed to the rod; and
a propeller rotatably mounted at the supporting axis.

18. The apparatus of claim 16, wherein the air resisting portion is constructed as a plurality of air bars provided at an upper side of the air tube.

19. The apparatus of claim 1, wherein the air tube is provided with a plurality of buffering protrusions for absorbing an impact when the air tube collides with the ground or a wall surface at an outer circumferential surface thereof.
